(19) United States
(12) Patent Application Publication
(10) Pub. No.: US 2025/0017415 A1
(43) Pub. Date: Jan. 16, 2025

(54) COOKING DEVICE AND METHOD OF USING

(71) Applicant: American Egg Board, Chicago, IL (US)

(72) Inventors: Seth Miller, Longmont, CO (US); Michael Keoni Manion, Santa Cruz, CA (US); Dennis Tyler Runyan, Seattle, WA (US); Mathieu Larronde-Larretche, Seattle, WA (US); Zackary Nathan Scholl, Seattle, WA (US); Nate Hedtke, Wauconda, IL (US); Nelson Serrano-Bahri, Glenview, IL (US); Michelle Titti, Seattle, WA (US); Joe Choi, Renton, WA (US); Brittany Kovacevic, Seattle, WA (US); Webb Girard, Renton, WA (US)

(21) Appl. No.: 18/771,797

(22) Filed: Jul. 12, 2024

Related U.S. Application Data
(60) Provisional application No. 63/513,855, filed on Jul. 14, 2023.

(51) Int. Cl. A47J 36/02; A47J 29/02; A47J 36/04; A47J 36/06; A47J 36/36; H05B 6/64

(52) U.S. Cl. CPC A47J 36/027; A47J 29/02; A47J 36/04; A47J 36/06; A47J 36/36; H05B 6/6494

(57) ABSTRACT

A cooking device and method that allow food, including eggs, to be cooked in a microwave or rapid cook oven are provided. The device includes a base having at least one receptacle with a base surface, the base having a susceptor that is embedded in a first insulator and positioned to be in thermal contact with the base surface, and at least one yolk cap having a phase change material embedded in a third insulator that is in thermal contact with the bottom surface of the yolk cap. The yolk cap is sized and shaped to cover at least a portion of the receptacle. A lid having a top surface, a bottom surface, a second insulator and at least one shield that is embedded in the second insulator and shaped to cover the receptacle is provided. The bottom surface of the lid is sized and shaped to cover the receptacle.

### PRIORITY CLAIM

This application claims the priority benefit of U.S. Provisional Patent Application Ser. No. 63/513,855, filed Jul. 14, 2023, the disclosure of which is incorporated herein by reference in its entirety.

### TECHNICAL FIELD

The subject matter described herein relates to a device for cooking food, such as eggs. In particular, an improved device that can be easily manipulated to quickly cook food in a microwave or rapid cook oven and provide the desired heat distribution to the food being cooked. The device allows the food, such as eggs, to be cooked quickly and to the desired outcome, such as a sunny-side-up egg with a runny yolk.

### BACKGROUND

Eggs can be prepared in a variety of ways. Eggs can be cooked to be hard boiled, soft boiled, scrambled, sunny-side-up, fried, etc. Many individuals, restaurants and quick serve restaurants (QSRs) would like the option to prepare a “sunny-side-up” fried egg with a runny yolk quickly. Typically, a sunny-side-up egg is produced by frying a whole shell egg on one side only, usually in oil or fat, over medium heat, in either a skillet or on a griddle. The egg must be monitored carefully to ensure the white is completely opaque as the white coagulates, and the yolk is warm but remains uncoagulated and thus runny.

Sunny-side-up eggs are one of the most common types of eggs and can be consumed individually, as part of a meal such as breakfast, or as an ingredient in a sandwich or hamburger. Compared to other types of prepared eggs, such as over-easy (where the egg is fried on both sides), scrambled (where the egg is beaten before cooking and mixed as it is cooked), sunny-side-up eggs have a much more natural appearance, particularly if the yolk is still runny and the white is not overcooked. Consumers associate this with freshness and quality as it is visually appealing. A properly cooked egg is crispy and has some Maillard (browning) on the bottom surface which adds a pleasing texture element to combine with the soft and runny textures of the rest of the egg. A sunny-side-up egg can be a valuable ingredient for many meals, particularly compared to other prepared egg styles.

To prepare a sunny-side-up egg, first, a cooking spray, oil or fat, such as butter, is heated in a skillet or on a griddle to a medium high heat. Next, an egg is cracked into the skillet or griddle. The egg is cooked until the whites are just set, which is about two minutes. Some cooks baste the whites with the hot oil in the skillet. Some cover the egg with a lid or inverted skillet until the whites are completely opaque and yolks are warmed through but still runny, which is about one minute longer. The eggs are then removed from the skillet or griddle and slid onto a plate to be served. The cooking time will depend on several factors, including the egg type, size and starting temperature, the heat of the skillet or griddle, the type of oil used and the preference for how cooked the egg is. This all requires some skill and attention during cooking to ensure the bottom of the egg is cooked to a suitable crispness, the egg whites are completely coagulated, and the yolk is warm but not set. It is difficult to manage many other tasks cooking an egg. There is a lot of room for error, as the yolk of the egg can break if the egg is cracked into a very warm skillet or griddle, the yolk of the egg can be overcooked, undercooked or broken when the egg is removed from the skillet.

The challenge for cooking and serving sunny-side-up eggs for individuals and in QSRs is that they often do not have a griddle or stovetop or sufficient cooking skills. Additionally, most QSR service patterns do not allow for the time it takes to cook eggs in this method, and, even for those that do, consistency and quality can be difficult to maintain. Since many QSRs offer food in response to an actual order (i.e., “to order”) or within a short amount of time in anticipation of upcoming orders (i.e., “to stock”), menu items are limited to very efficient preparation methods with very strict standard operating procedures. To reduce cooking time for both individuals and QSRs, it is increasingly common for hot menu items to be prepared in either a microwave oven or rapid cook oven, which combines multiple cooking methods, such as microwave and high temperature convection and/or impingement.

QSR business models typically rely on very fast preparation times, often with limited equipment and employees with limited culinary skill. QSRs need to have fast turnover times, while still managing quality and consistency, as repeat customer purchases suffer when consumer experience is compromised. QSR menu items are typically limited in scope and require minimal preparation. For hot items, it is increasingly common that QSRs use microwave or rapid cook ovens to quickly heat individual servings of a product on order. Thus, ingredients such as sunny-side-up eggs, are not feasible for many of these settings due to the time, skill and facilities available.

Microwave ovens heat food using microwaves, a form of non-ionizing electromagnetic radiation, produced by a magnetron inside the oven. The microwaves are reflected within the metal interior of the oven where they are absorbed by food where they cause water molecules to vibrate, producing heat that cooks the food. For many foods, the outer layers are cooked by this effect, while the inner layers are cooked by the conduction of heat from the hot outer layers.

Rapid cook ovens, also called high speed ovens, utilize at least two methods of heat transfer, usually at least one of them being microwave in combination with least convection, impingement or radiant heating. Rapid cook ovens offer cook times that are many times faster than a conventional oven, are versatile and offer superior control over cooking, and offer increased menu flexibility. Many rapid cook ovens are ventless and can be compact, and, in QSRs, are used in front-of-house to increase speed of service for heat-and-serve operations. If the food going in is consistent, rapid cook ovens are typically very good at consistently cooking a product to the same level of doneness.

Contrary to cooking on a stove top or in a conventional oven, egg yolks cook faster in microwave ovens. Without being bound by theory, this may be because they have a higher fat content and a lower heat capacity, and thus the temperature rises more quickly for the same energy input. This effect was verified, as shown in FIGS. 1A-1C experimentally with thermal imaging inside a microwave oven demonstrating the rapid heating of the yolk precedes that of the egg white. FIGS. 1A-1C show the thermal imaging of an egg white 300, an egg yolk 302 and a cooking vessel 304. FIG. 1A shows the thermal imaging of egg white 300, egg yolk 302 and cooking vessel 304 at 0 seconds. FIG. 1B shows the thermal imaging of the egg white 300, egg yolk 302 and cooking vessel 304 after 10 seconds in the microwave. FIG. 1C shows the thermal imaging of egg white 300, egg yolk 302 and cooking vessel 304 after 20 seconds in the microwave. Thus, preparing a sunny-side-up egg consistently with set white and runny yolk is very difficult using a microwave. Also, the texture of the egg white when cooked in a microwave is often rubbery, mainly due to the egg getting too hot and overcooking, causing rapid protein denaturation and moisture loss. Further, the bottom of the egg will not achieve a higher temperature than the rest of the egg cooking in a microwave, so there is limited, if any, crisping of the bottom of the egg. There is also a problem of superheating of water inside the egg, which can lead to rapid expansion and ultimately an explosion of the egg when cooked in a microwave oven. This can be messy and a significant burn danger for cooks.

For these reasons, microwave and rapid cook oven methods are not suitable for producing sunny-side-up eggs. Typically, these rapid cook methods result in uniform cooking of the egg, resulting in a yolk that is cooked to the same temperature as the egg white, rather than being runny.

Beyond QSRs and other types of restaurants, many individuals cooking at home utilize microwave or rapid cook ovens for speed, convenience and due to their lack of cooking skills. Since the same problems exist for cooking a sunny-side-up egg in the home, the home cook is similarly limited.

A wide variety of microwave cooking devices exist and are commercially available. Specifically, many devices exist to cook eggs in the microwave such as the Maconee Microwave Egg Cooker, the Chef Buddy Egg Maker and the Plainele Microwave Egg Poacher. The essential elements of most known cookers include a pan or receptacle to hold the egg while cooking, along with a cover. The devices can be coated in materials to absorb the microwaves from the microwave oven and turn them into thermal energy which is conveyed from the metal into the food being cooked. Many microwave devices focus on the ability for easy cleaning and removal of the food, such as eggs. Other devices claim to have special material on the bottom of the cooking device which causes the material to heat quickly from the bottom akin to an electric or gas stove. Many of these devices will produce a cooked egg, or other food item, quickly, however the yolk will be cooked through and not remain runny.

Many of these existing cooking devices use microwave susceptors or microwave-safe plastics to create poached or baked eggs. Microwave susceptors are materials, usually metalized thin films, ceramics or metals, such as aluminum flakes embedded in a polymer matrix, that absorb microwave radiation at a higher rate and heat up to a much higher temperature than the food the susceptor is thermal contact with. Microwave susceptors are therefore useful for crisping and can be used to mimic the action of frying an egg in a pan with respect to the bottom of the egg. However, the other problems associated with cooking an egg in a microwave, such as the yolk cooking faster than the egg white, rubbery texture of the egg due to rapid overcooking and superheating of water inside eggs resulting in explosion, still prevail. There is no commercial solution for a device to produce a sunny-side-up egg in a microwave oven.

Several complex standalone devices for automating the cooking of sunny-side-up eggs have been proposed, however, for most QSRs, the cost of these systems and the space limitations within the restaurant prevents these from being viable options. QSRs need to leverage the equipment and space available to prepare as many different items as possible, rather than having dedicated systems just for a single ingredient, such as sunny-side-up eggs.

Therefore, there is a need for a device that allows users to cook a fried egg rapidly and reliably with a runny yolk, in a microwave or rapid cook oven. Such a device would allow home or restaurant cooks to conveniently cook sunny-side-up eggs without the need for a skillet and range or advanced cooking skills. Such a device would also allow all cooks to produce high quality sunny-side-up eggs consistently and efficiently.

### SUMMARY

The subject matter described herein seeks to solve the challenge of consistently cooking a sunny-side-up egg by providing a cooking device that eliminates the need for a) advanced cooking skill, b) an extending cooking time, and c) a cooking skillet or pan which achieves the purpose set forth above.

The cooking device described herein that allows food to be cooked in a microwave or rapid cook oven has a base having a top surface and a bottom surface, the base having at least one receptacle, wherein the receptacle extends from the top surface of the base towards the bottom surface of the base forming a cavity having a base surface, the base comprises a susceptor and a first insulator, wherein the susceptor is embedded in the first insulator, wherein the susceptor is positioned to be in thermal contact with the base surface of the receptacle and a lid having a top surface and a bottom surface, the lid comprising a second insulator and at least one shield, wherein the shield is embedded in the second insulator and shaped to cover the receptacle, wherein the bottom surface of the lid is sized and shaped to cover the receptacle.

In one example, the cooking device described herein has a base having a top surface and a bottom surface, the base having at least one receptacle, wherein the receptacle extends from the top surface of the base towards the bottom surface of the base forming a cavity having a base surface, the base comprises a susceptor and a first insulator, wherein the susceptor is embedded in the first insulator, wherein the susceptor is positioned to be in thermal contact with the base surface of the receptacle and at least one yolk cap having a top surface and a bottom surface, the yolk cap comprising a phase change material and a third insulator, wherein the phase change material is embedded in the third insulator, wherein the phase change material is in thermal contact with the bottom surface of the yolk cap, and wherein the yolk cap is sized and shaped to cover at least a portion of the receptacle.

In one example, the cooking device has a base as described, wherein the base has a phase change material in thermal contact with the bottom surface of at least a portion of the base receptacle.

In one example, the cooking device has a base as described, the yolk cap as described and the lid as described wherein the bottom surface of the lid is sized and shaped to cover the receptacle and the yolk cap.

In one example, the bottom surface of the lid is a dome. The bottom surface of the lid can have various shapes and sizes and can be sized to cover various foods that are placed within the receptacle.

In one example, the cooking device has a base as described, the yolk cap as described and the lid as described wherein the yolk cap is integrated into the lid and positioned so as to be suspended over at least a portion of the receptacle when the lid is placed on the base.

In one example, the base has a plurality of receptacles and a plurality of susceptors, wherein the susceptors are positioned to be in thermal contact with the base surfaces of the receptacles, a plurality of yolk caps, wherein the yolk caps are capable of covering at least a portion of each receptacle, and the lid having a plurality of shields, the bottom surface of the lid is shaped to cover the receptacles in the base wherein each shield is positioned over each receptacle and each egg yolk.

In one example, the base has two receptacles and two susceptors, two yolk caps and one lid having two shields, the bottom surface of the lid is shaped to cover the receptacles in the base wherein each shield is positioned over each receptacle and each yolk cap. This allows the cooking device to cook two eggs or food items at the same time.

In one example, the base has more than two receptacles and more than two susceptors, more than two yolk caps and one lid having more than two shields, the bottom surface of the lid is shaped to cover the receptacles in the base wherein each shield is positioned over each receptacle and each yolk cap. This allows the cooking device to cook multiple eggs or food items at the same time.

In one example, the susceptor is embedded within the first insulator in between the base surface of the receptacle and the bottom surface of the base and thermally insulated from the bottom surface of the base.

In one example, the base surface is circular.

In one example, the surface of the receptacle is shaped so as to hold the yolk of an egg in a position that is aligned with the yolk cap when the yolk cap and the lid are placed on top.

The base surface may also have alternative shapes such as square, rectangular, free form, heart, or diamond.

In one example, the base has a first side and a second side and two handles, wherein one handle extends outwardly from each side.

In one example, the base and the lid have a mechanism for self-alignment, such as tabs that hold together when the lid is placed onto the base. In one example, this mechanism holds the yolk cap directly over the yolk of the egg and ensures the egg does not move when the device is being moved, such as from a countertop into an oven.

In one example, the first insulator, second insulator and third insulator are made from silicone, such as high-heat food grade silicone.

In one example, the yolk cap has the shape of a dome and is sized and shaped to cover at least a portion of an egg yolk that is placed in the receptacle. The yolk cap may be held in a position above the white of the egg so as to not be in contact with the egg white as the egg white is setting in the oven.

The yolk cap can also have alternative shapes such as square, round, rectangular and shaped to cover other food products.

In one example, the yolk cap can be fixedly attached to a cage, the cage is sized to fit within the receptacle and hold the yolk cap in a fixed position.

In one example, the phase change material has a transition temperature below 65 degrees Celsius.

In one example, the phase change material is made from CrodaTherm60. Another example of a material that can be used as the phase change material is beeswax. In addition, the subject matter described herein is not limited to phase change materials with a transition temperature below 65 degrees Celsius. Phase change materials, such as waxes other than beeswax, with a transition temperature below 60 degrees Celsius are also suitable for use with the subject matter described herein.

In one example, the yolk cap can be fixed to the lid or an integral component of the lid.

In one example, the shield is made of an electrically conductive metal such as aluminum, steel, copper, brass, nickel, silver or tin.

A method of cooking food in a microwave includes providing a base having a top surface and a bottom surface, the base having at least one receptacle. The receptacle extends from the top surface of the base towards the bottom surface of the base forming a cavity having a base surface, the base comprising a susceptor and a first insulator. The susceptor is embedded in the first insulator. The susceptor is positioned to be in thermal contact with the base surface of the receptacle, providing at least one yolk cap having a top surface and a bottom surface. The yolk cap includes a phase change material and a third insulator. The phase change material is embedded in the third insulator, and the phase change material is in thermal contact with the bottom surface of the yolk cap. The yolk cap is sized and shaped to cover at least a portion of the receptacle, providing a lid having a top surface and a bottom surface. The lid includes a second insulator and a shield. The shield is embedded in the second insulator and shaped to cover the receptacle in the base and the yolk cap. The bottom surface of the lid is sized and shaped to cover the receptacle in the base and the yolk cap, providing a cracked egg in the receptacle of the base having an egg white and an egg yolk, aligning the yolk cap over the egg yolk, aligning the lid over the base and the yolk cap, providing a microwave, and cooking the base with the egg in the receptacle, with the yolk cap over the egg yolk, with the lid over the base and the yolk cap in the microwave for approximately 1 to 2 minutes on high heat to provide a sunny-side-up egg.

According to another aspect of the subject matter described herein, a method of cooking food in a microwave or rapid cook is provided. The method includes providing or obtaining a cooking device comprising a base having a top surface and a bottom surface, the base having at least one receptacle, wherein the at least one receptacle extends from the top surface of the base towards the bottom surface of the base forming a cavity having a base surface, the base comprising a susceptor and an insulator, wherein the susceptor is embedded in the insulator, wherein the susceptor is positioned to be in thermal contact with the base surface of the at least one receptacle. The method further includes providing or obtaining, as part of the cooking device, at least one yolk cap having a top surface and a bottom surface, the at least one yolk cap comprising a phase change material and an insulator, wherein the phase change material is embedded in the insulator of the at least one yolk cap, wherein the phase change material is in thermal contact with the bottom surface of the at least one yolk cap, and wherein the at least one yolk cap is sized and shaped to cover at least a portion of the at least one receptacle. The method further includes providing or obtaining, as part of the cooking device, a lid having a top surface and a bottom surface, the lid comprising an insulator and a shield, wherein the shield is embedded in the insulator of the lid and shaped to cover the receptacle in the base, wherein the bottom surface of the lid is sized and shaped to cover the at least one receptacle in the base. The method further includes placing at least one cracked egg having at least one egg white and at least one egg yolk in the at least one receptacle of the base. The method further includes placing the lid on the base with the at least one yolk cap aligned over the at least one egg yolk. The method further includes placing the cooking device including the at least one cracked egg in a cooking chamber of a microwave or rapid cook oven. The method further includes activating the microwave or rapid cook oven to cook the at least one egg.

It is anticipated that the cooking device described herein can also be used to cook food or an egg in a rapid cook oven.

In one example, the method described above can be used to cook an egg in a rapid cook oven, where the cooking device with the food therein may be cooked for approximately 1 to 2 minutes on high heat of approximately 500 degrees Fahrenheit, with 50% microwave intensity and 50% air impingent to provide a sunny-side-up egg.

It is anticipated that the cooking device and method of using can be used to cook other food products other than eggs.

### BRIEF DESCRIPTION OF THE DRAWINGS

The subject matter described herein will now be explained with reference to the accompanying drawings, of which:

FIGS. 1A-1C illustrates thermal imaging of an egg cooking in a microwave;

FIG. 2 is a side cross sectional view of a cooking device;

FIG. 3 is an exploded perspective view of the base of another example of the cooking device with eggs;

FIG. 4 is a perspective view of the cooking device with an egg in each receptacle;

FIG. 5 is a perspective view of the cooking device with the yolk cap in an open position;

FIG. 6 is a perspective view of the cooking device with the yolk cap in a closed position;

FIG. 7 is a top perspective view of the lid of the cooking device;

FIG. 8 is a bottom perspective view of the lid of the cooking device;

FIG. 9 is the cross-sectional view of the lid of the cooking device taken on the line A-A;

FIG. 10 is a perspective view of the cooking device with the lid in an open position;

FIG. 11 is a perspective view of the cooking device with the lid in a closed position;

FIG. 12 is a cross sectional view of the yolk cap of FIGS. 5 and 6;

FIG. 13 illustrates another example of a cross sectional side view of a cooking device;

FIGS. 14A-14C illustrate another example of a cooking device;

FIGS. 15A-15D are images of a cooking device, and FIG. 15E is an image of a sunny-side up-egg cooked using the cooking device; and

FIGS. 16A-16C are images of a cooking plate and a susceptor prior to silicone overmolding.

### DETAILED DESCRIPTION

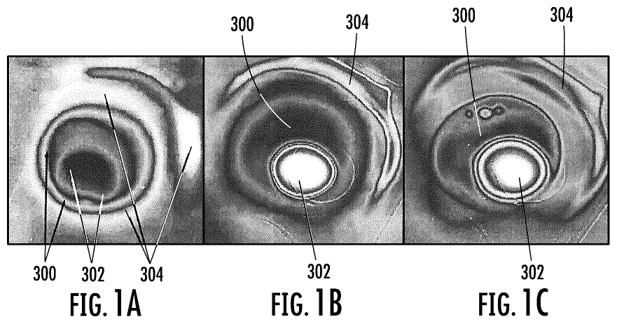

With reference to the drawings, wherein the same reference number indicates the same element throughout, there is shown in FIGS. 1A-1C thermal imaging of an egg cooking in a microwave oven. FIG. 1A shows an egg white 300, an egg yolk 302 and a cooking vessel 304 at zero seconds of being cooked in a microwave oven. FIG. 1B shows egg white 300, egg yolk 302 and cooking vessel 304 at ten seconds of being cooked in a microwave oven. FIG. 1C shows egg white 300, egg yolk 302 and cooking vessel 304 at twenty seconds of being cooked in a microwave oven. FIGS. 1A-1C show that when an egg is cooked in a microwave oven, egg yolk 302 is cooked much faster than egg white 300.

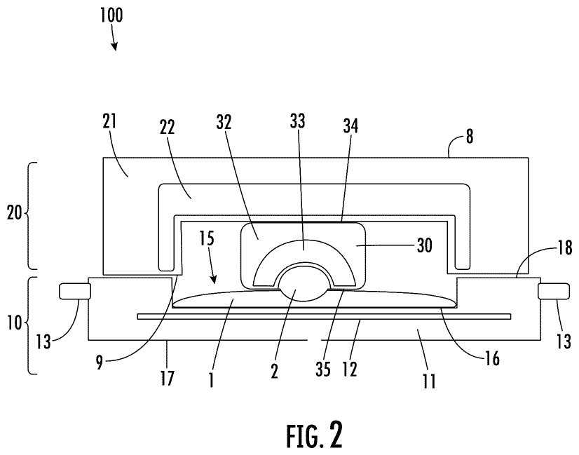

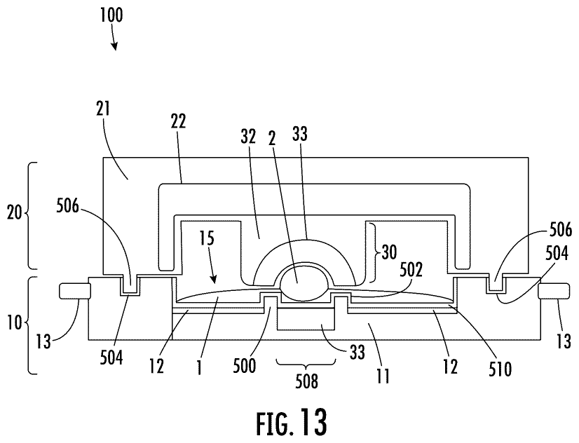

FIG. 2 illustrates an example of a cooking device according to the subject matter described herein. As shown in FIG. 2, cooking device 100 includes a base 10, a lid 20 and a yolk cap 30. Cooking device 100 shown in FIG. 2 has a similar structure and contains the same elements as shown in an alternative cooking device 400 (described below), except that cooking device 100 is structured to cook one egg. In cooking device 100, base 10 has a top surface 18 and a bottom surface 17, includes at least one receptacle 15 that extends from top surface 18 of base 10 towards bottom surface 17 of base 10, forming a cavity having a base surface 16 and capable of housing a cracked egg. In one example base 10 includes two receptacles 15 to house two cracked eggs. It is contemplated that base 10 can include one receptacle 15 or a plurality of receptacles 15 to cook numerous eggs at the same time. In one example, base surface 16 of receptacle 15 has a circular shape. It is contemplated that base surface 16 or receptacle 15 may have other shapes to create a final shape of the cooked egg, such as a square, rectangle, triangle, heart, etc. Similarly, receptacle 15 may be shaped or sized to position egg yolk 2 in a specific position in relation to egg white 1 or to align with lid 20. Egg yolk 2 may be positioned by a yolk holder comprising a raised edge (shown in FIGS. 13, 14A-14C, and 16A) on base surface 16 of receptacle 15 to hold egg yolk 2 in place when the egg is cracked into receptacle 15. This raised edge may be a circle of approximately 4-6 cm diameter and approximately 1-5 mm higher than the rest of the surface of receptacle 15 for the egg, such that when the egg is cracked into receptacle 15, the raised edge forms a well to contain egg yolk 2, while egg white 1 will be housed in the rest of receptacle 15.

As shown in FIG. 2, base 10 also includes a susceptor 12 and a first insulator 11. Susceptor 12 is positioned to be below and in thermal contact with base surface 16 of receptacle 15. In another example, base surface 16 is susceptor 12. It is contemplated that at least some portion of receptacle is in thermal contact with susceptor 12. As at least a portion of receptacle 15 is in contact with egg white 1 and is also in thermal contact with susceptor 12 to absorb electromagnetic radiation and convert the electromagnetic radiation to heat. This heat is transferred to the bottom of egg white 1, either through conduction or infrared radiation, to provide a high temperature cooking effect at base surface 16, resulting in a crispy texture on the bottom of egg white 1. It is contemplated that an oil or fat, such as butter, may be added between base surface 16 and egg white 1 to aid in browning of the bottom of egg white 1. Further, base surface 16 may have a non-stick coating, such as polytetrafluoroethylene (PTFE), ceramic or other non-stick material. For conduction heating, susceptor 12 is in good thermal contact with egg white 1, resulting in some crisping of egg white 1. For infrared heating, a higher temperature can be achieved if susceptor 12 is not in as good thermal contact with egg white 1, which can result in higher temperatures of susceptor 12 being achieved due to its smaller heat capacity. This can be achieved by having an air gap or a poor thermal conductor between the susceptor and the egg (not shown). Infrared heating may result in more browning and crisping from a “broiling” type effect due to the low ability for the infrared radiation to penetrate the egg, cooking more at the surface.

Susceptor 12 may be constructed from metalized thin films, ceramics or metals such as aluminum flakes. As shown in FIG. 2, susceptor 12 may be embedded within first insulator 11 within base 10. As susceptor 12 is embedded within first insulator 11, susceptor 12 may be entirely surrounded by first insulator 11, or susceptor 12 may extend out of first insulator 11. That is, susceptor 12 may not be entirely surrounded by first insulator 11. It is contemplated that susceptor 12 may be thermally insulated from base 10. It is contemplated that base 10 has bottom surface 17 and susceptor 12 may be thermally insulated from bottom surface 17 of base 10. This can be accomplished with food grade silicone to provide for safe handling of base 10. It is contemplated that base surface 16 of receptacle 15 is lined with a non-stick surface to facilitate cleaning of base 10 after an egg is cooked therein. As used herein, “embedded” is defined as fixed into a surrounding mass or fixed into a surface while a piece or portion is exposed from the mass.

Base 10 may include handles 13 which extend radially outward from base 10 and allow a user to hold base 10.

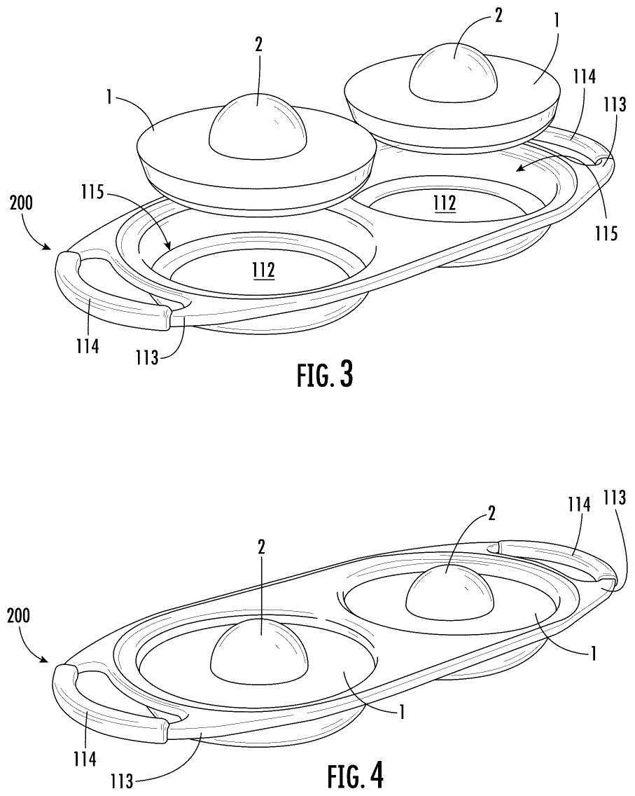

FIGS. 3 and 4 show another example where base 200 includes a susceptor 112 in thermal contact with the bottom of the egg white 1. FIG. 3 shows two receptacles 115, each capable of accepting a cracked egg, where a cracked egg is housed within each receptacle 115. Each receptacle 115 is shaped to allow each egg white 1 to be in thermal contact with susceptor 112 located in each receptacle 115. It should be noted that each susceptor 112 may not be in physical contact with each egg white 1 and may instead be separated from each egg white 1 by a cooking surface made from a metallic material coated with a non-stick coating. FIG. 3 further shows that handles 113 may contain grips 114. Grips 114 may be made from a material that protects a user from burning their hands. FIG. 4 shows the eggs within the receptacles 115 of base 200 where the bottom of egg white 1 is in thermal contact with susceptor 112.

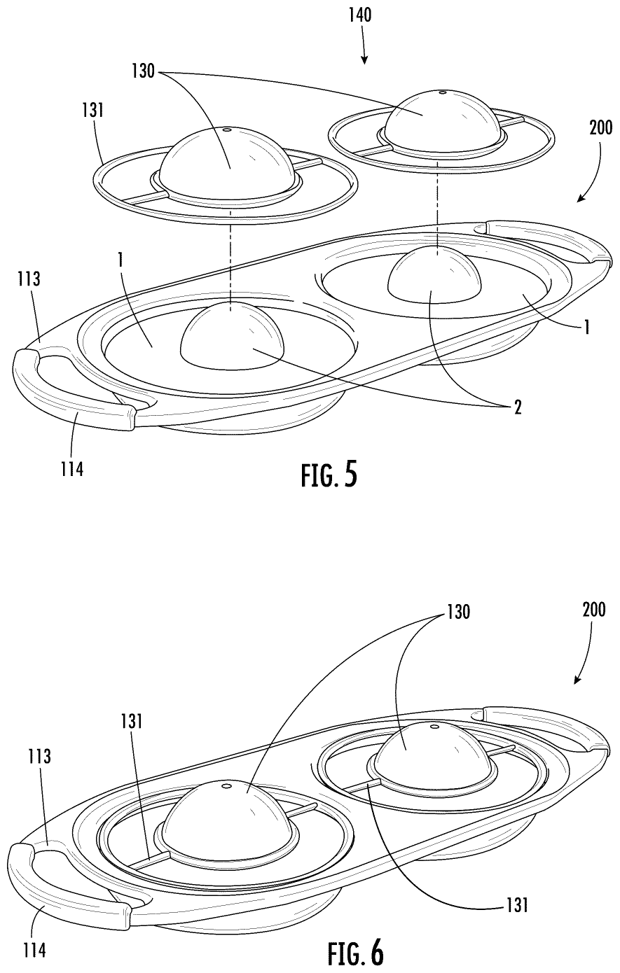

FIGS. 5 and 6 show one example where each yolk cap 130 is fixedly connected to a cage 131. It is contemplated that yolk cap 130 be used without cage 131. In this example, cage 131 is sized and shaped to fit within receptacle 115 and on top of egg white 1, while yolk cap 130 is sized and shaped to fit within receptacle 115 and cage 131 and on top of egg yolk 2. Cage 131 can be sized and shaped to orient egg yolk 2 into a desired location or a fixed location within receptacle 115. In one example, cage 131 is sized and shaped to mirror the size and shape of receptacle 115 and to fit therein. As shown, yolk cap 130 is sized and shaped to concentrically nest within cage 131 and has the shape of a dome. It is contemplated that yolk cap 130 may have various shapes and sizes. In this example, yolk cap 130 and cage 131 together form an independent piece of cooking device 100. It is contemplated that yolk cap 130 may be integrated into lid 120 or removably attached to lid 120. Yolk cap 130 is in thermal contact with at least the top of egg yolk 2 within receptacle 115. Yolk cap 130 functions to slow the cooking of egg yolk 2 and allow egg yolk 2 to remain runny.

As shown in FIG. 12, allowing egg yolk 2 to remain runny while egg white 1 is cooked to a crispy state may be accomplished as yolk cap 130 has a third insulator 132 to reduce convective heating, such as when the egg is in a rapid cook oven. Third insulator 132 may be a thermal insulator, such as a food grade silicone or some other heat-tolerant, food-grade elastomer to be placed between egg yolk 2 and the heat source, such as a microwave or rapid cook oven. Third insulator 132 may be made from a material to prevent egg residue from sticking during the cooking process. Third insulator 132 may also have a low specific heat such that third insulator 132 promotes heat energy transmission between phase change material 133 and egg yolk 2. Third insulator 132 may have a high enough rigidity to maintain its shape when phase change material 133 transitions to liquid.

As shown in FIG. 12 (which works the same as yolk cap 30 shown in FIG. 1, yolk cap 130, 30 contains phase change material 133, 33 that is embedded in third insulator 132, 32 and allows phase change material 133, 33 to be in thermal contact with egg yolk 2. Phase change material 133, 33 is a material that provides thermal mass to slow the rate of heating of the top of egg yolk 2 near yolk cap 130, 30. More specifically, phase change material 133, 33 absorbs sufficient energy as the phase of phase change material 133, 33 transitions from a solid to a liquid to maintain a set temperature before the energy can be used to heat the liquid further. As the material transitions from a solid to a liquid, a large amount of heat is absorbed as the heat of fusion is much higher than the sensible heat. Because egg yolk 2 sets at 65° C., phase change material 133, 33 is chosen to have a transition temperature below 65° C. One material that can be used for the phase change material 133, 33 is CrodaTherm 60, which is food-grade, has a melting point at 60° C., has a high latent heat capacity of 217 KJ/kg, and CrodaTherm 60 melts/crystallizes reversibly with very little loss. Croda Therm 60 can prevent materials that it is in thermal contact with from heating up beyond 60° C. during phase transition. The mass of phase change material 133, 33 required to achieve this depends on the size of the egg, the cooking method employed, the type of phase change material 133, 33, and the thickness of phase change material 133, 33. For example, in the case of a large AA egg cooked in a 1200W microwave oven, phase change material 133, 33 is approximately 15 g of CrodaTherm 60 formed into a 3 mm thick hemisphere and embedded in third insulator 132, 32 which is 0.5-1 mm of SmoothSil 940 silicone. This combination is sufficient to protect egg yolk 2 from setting during a 2-minute cook cycle. Alternatives to phase change material 133, 33 may also be utilized as long as they have sufficient thermal mass to prevent egg yolk 2 from gelling during the cooking process. Phase change material 133, 33 is particularly advantageous in allowing for a far thinner profile and smaller mass than non-phase-change alternatives.

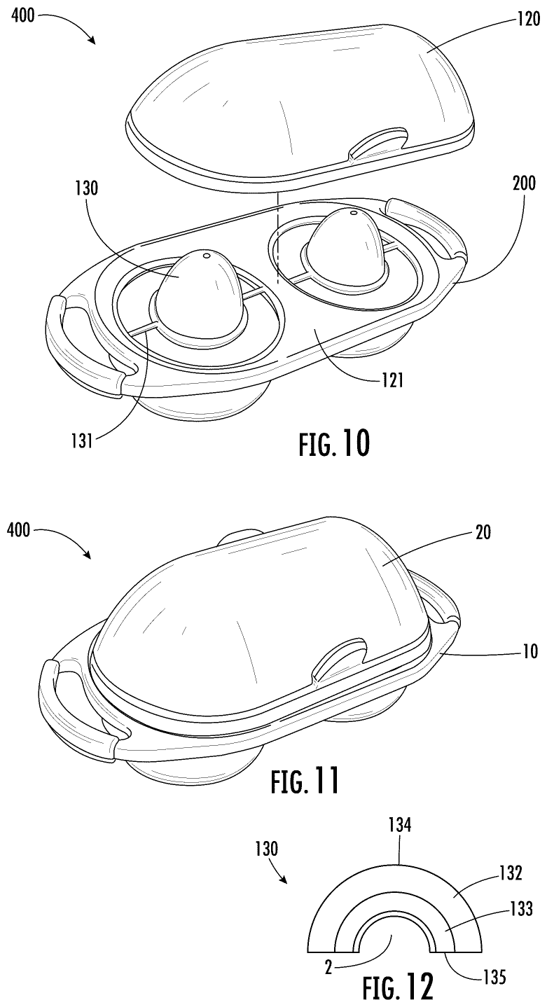

In one example, phase change material 133, 33 is embedded within third insulator 132, 32 within yolk cap 130 or 30. Phase change material 133, 33 is embedded so that phase change material 133, 33 is not capable of escaping from third insulator 132, 32 when phase change material 133, 33 is in liquid phase during the cooking process. Phase change material 133, 33 is capable of being in thermal contact with egg yolk 2 that is within receptacle 115, 15. In one example, third insulator 132, 32 will embed phase change material 133, 33 and extend over phase change material 133, 33 to form a thicker layer over phase change material 133, 33 then under it. As set forth above, yolk cap 130, 30 has a cup shape, or dome shape, with the inner diameter equivalent to the size of egg yolk 2, which is approximately 3-4 cm. Yolk cap 130, 30 is arranged so that yolk cap 130, 30 is positioned over egg yolk 2 and covers as much of egg yolk 2 as possible. It may be necessary to include a means to position either egg yolk 2 or yolk cap 130, 30 or both, so that they are aligned. In some embodiments, yolk cap 130, 30 is a separate piece of the device as shown in FIGS. 5, 6 and 10. It is contemplated that yolk cap 130, 30 may have the ability to be positioned with respect to the egg and base 200, 10 and cover egg yolk 2 without interfering with the rest of the egg during the cooking process. In other examples, yolk cap 130, 30 may be integrated into lid 120, 20.

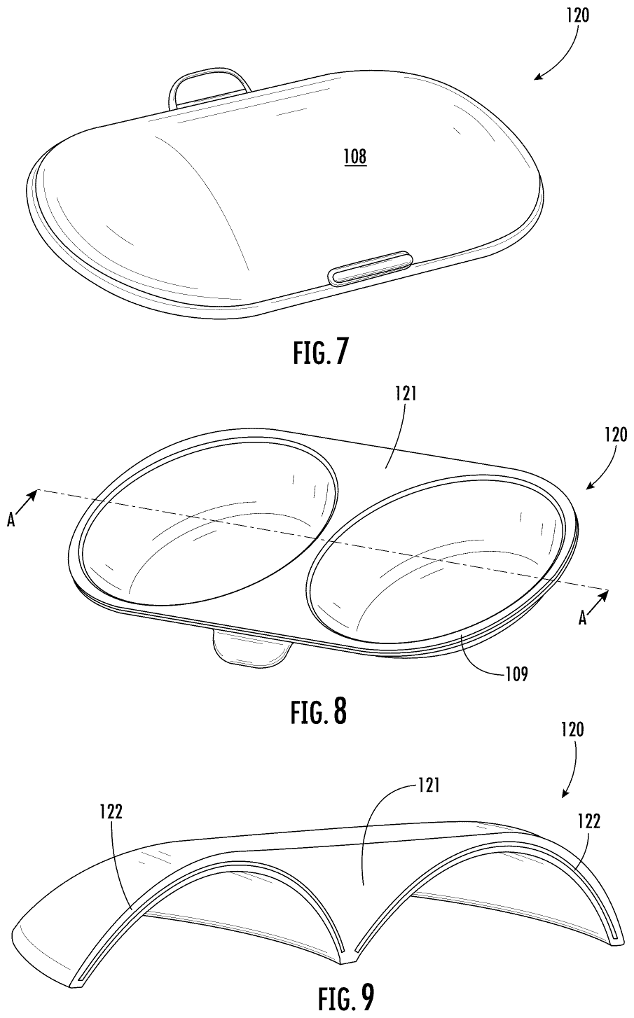

FIGS. 7-11 show a lid 120 of cooking device 100. Lid 120, 20 is similar and has the same structure as lid 20 in FIG. 2. Lid 120, 20 has a top surface 108, 8 and a bottom surface 109, 9 and comprises a shield 122, 22 and a second insulator 121, 21. Second insulator 121, 21 embeds shield 122, 22 within lid 120, 20. Lid 120, 20 is sized and shaped to mate with base 200, 10 and enclose base 200, 10. Bottom surface 109, 9 of the lid is sized and shaped to cover receptacle 115, 15. In the example shown in FIGS. 7-11 cooking device 400 is capable of cooking two eggs. In the example shown in FIG. 1, cooking device 100 is capable of cooking one egg. It is contemplated that the cooking device be shaped and sized to cook a single egg or a plurality of eggs at the same time.

Lid 120, 20 provides a shield against the microwave and convective heating of the egg during the cooking process. Lid 120, 20 acts to reduce the electromagnetic radiation, especially microwaves, from reaching the egg within cooking device 400 during the cooking process and slows down the cooking. The microwave radiation is therefore directed away from the top surface of egg white 1 and egg yolk 2 and to susceptor 112, 12 within base 200, 10. This concentrates heat to the bottom surface of egg white 1, mimicking the pan frying of an egg. Shield 122, 22 may be constructed from an electrically conductive material, such as aluminum, copper, brass, nickel, silver, steel or tin that is arranged to cover the egg like a Faraday cage. Shield 122, 22 is embedded within second insulator 121, 21. Shield 122, 22 may be completely surrounded by second insulator 121, 21 or shield 122, 22 may extend out of second insulator 121, 21. Second insulator 121, 21 may be a food-safe insulation.

The structure of lid 120, 20 reduces the cooking rate of the eggs in the cooking device by shielding the lumen of the device from environmental heat. In rapid cook ovens, lid 120, 20 reduces the convective and/or impingement heating on the top surface of the egg. In addition to protecting the egg from environmental conditions, lid 120, 20 serves additional functions. If superheating of the egg occurs, lid 120, 20 acts as a physical barrier to splatter or explosion of the egg. Lid 120, 20 reduces the mess and improves the safety of cooking device 400, 100. The isolation of lid 120, 20 also traps moisture escaping the egg during the cooking process, which helps reduce the negative drying effects that occur in rapid cook scenarios. Lid 120, 20 may be comprised of shield 122, 22 and second insulator 121, 21 made from a silicone-lined steel cage using thin sheet metal and high temperature food-grade silicone. Shield 122, 22 can be a box, dome, or any other shape so long as shield 122, 22 covers the entire egg, and rests on top of receptacle 115, 15, to provide a loose-fitting seal with gaps no greater than 1.5 mm between the metal of the lid and the metal of the receptacle. 1.5 mm is selected as the maximum gap to prevent microwave radiation from entering the cavity formed by the lid and receptacle. This effectively acts as a Faraday cage against microwave radiation, so that the egg inside has dramatically lower exposure. Thus, the microwave radiation is mostly directed to susceptor 112, 12 within the base 200, 10 of the cooking device 400, 100, such that the egg is dominantly heated from the bottom similar to how the egg would be heated in a frying pan.

The method of cooking a sunny-side-up egg using the cooking device 100, 400 comprising providing a base 200, 10 having a top surface 118, 18 and a bottom surface 117, 17. Base 200, 10 has at least one receptacle 115, 15, wherein the receptacle extends from the top surface 118, 18 of base 200, 10 towards the bottom surface 117, 17 of the base 200, 10 forming a cavity having a base surface 16, 116. The base includes susceptor 112, 12 and first insulator 111, 11. Susceptor 112, 12 is embedded in first insulator 111, 11. Susceptor 112, 12 is positioned to be in thermal contact with base surface 116, 16 of the receptacle, providing at least one yolk cap 130, 30 having top surface 34, 134 and a bottom surface 35, 135. Yolk cap 130, 30 includes phase change material 133, 33 and third insulator 132, 32. Phase change material 133, 33 is embedded in third insulator 132, 32. Phase change material 133, 33 is in thermal contact with bottom surface 135, 35 of yolk cap 130, 30. Yolk cap 130, is sized and shaped to cover at least a portion of receptacle 115, 15. The method further includes providing lid 120, 20 having top surface 108, 8 and bottom surface 109, 9. Lid 120, 20 includes second insulator 121, 21 and shield 122, 22. Shield 122, 22 is embedded in second insulator 121, 21 and shaped to cover receptacle 115, 15 in base 10, 200 and yolk cap 130, 30. Bottom surface 109, 9 of lid 120, 20 is sized and shaped to cover receptacle 115, 15 in base 200, 10 and yolk cap 130, 30. The method further includes providing a cracked egg in each receptacle 115, 15 of the base, where each egg includes egg white 1 and egg yolk 2. The method further includes aligning yolk cap 130, over each egg yolk 102, 2 and aligning the lid over base 200, 10 and yolk cap 130, 30. The method further includes providing a microwave and cooking the base with the egg in receptacle 115, 15, with yolk cap 130, 30 over egg yolk 2, with lid 120, 20 over the base 200, 10 and the yolk cap 130, 30 in the microwave for approximately 1 to 2 minutes on high heat to provide a sunny-side-up egg.

FIG. 13 illustrates another example of a cross sectional side view of a cooking device. Referring to FIG. 13, cooking device 100 includes many of the same components as cooking device 100 illustrated in FIG. 2. However, cooking device 100 illustrated in FIG. 13 includes a yolk holder 500 comprising a raised annulus 502 forming a well for positioning egg yolk 2 in the center of base 10. Base 10 further includes alignment notches 504 that are configured to receive corresponding alignment tabs 506 on lid 20 to align base 10 and lid 20. The depth of alignment notches 504 may be less than the vertical height of alignment tabs 506 to create a vertical gap between yolk cap 30 and base 10 so that yolk cap 30 will not create a dent or circular impression in egg white 1 during cooking. It should be noted that the gap in the vertical direction between shield 22 and base 10 created by alignment notches 504 and alignment tabs 506 may be less than one wavelength at microwave cooking frequencies to avoid direct microwave heating of the egg during cooking. It should also be noted that in FIG. 13, while alignment notches 504 are formed in base 10, and alignment tabs 506 are formed in lid 20, the subject matter described herein is not limited to such an implementation. In an alternate implementation, alignment notches 504 may be formed in lid 20, and alignment tabs 506 may be formed in base 10.

In cooking device 100 illustrated in FIG. 2, phase change material 33 is located only above egg yolk 2. In the cooking device 100 illustrated in FIG. 13, phase change material 33 is located both above and below egg yolk 2. In FIG. 13, the portion of phase change material 33 formed in yolk cap 30 has a dome shape. The portion of phase change material located below yolk holder 500 has a disc shape and is located in a central aperture 508 formed by susceptor 12. In FIG. 13, susceptor 12 comprises an annulus or ring structure that forms central aperture 508. In an alternate implementation, susceptor 12 may be a continuous disc without a central aperture. In such an implementation, the portion of phase change material 33 located in base 10 may be centered and located on top of susceptor 12.

A metal cooking plate 510 is located on top of both susceptor 12 and the portion of phase change material 33 located in base 10. Metal cooking plate 510 may be made of any suitable metal or other material that conducts heat. For example, metal cooking plate 510 may be made of aluminum, steel, copper, iron, or other heat conducting material. Metal cooking plate 510 may be coated with a non-stick coating, such as PTFE, to reduce sticking of the egg to base 10 and facilitate cleaning of base 10.

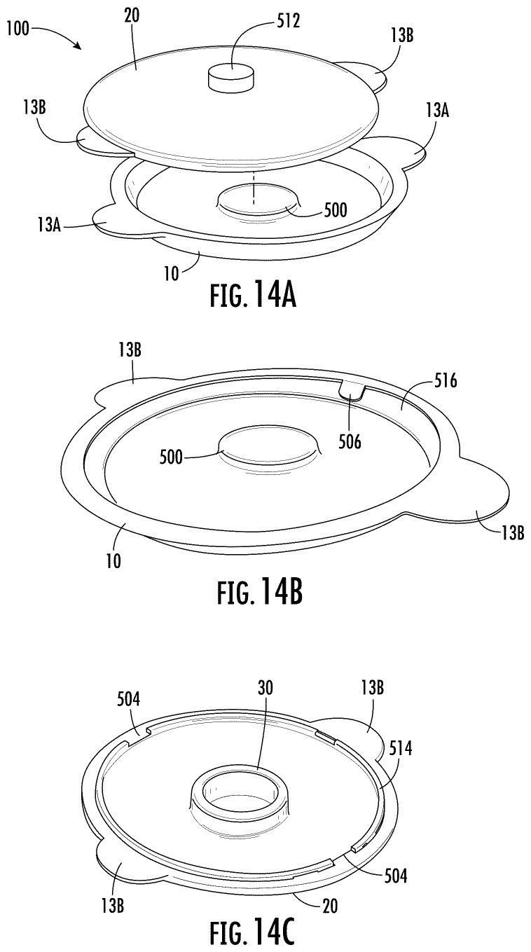

FIGS. 14A-14C illustrate another example of cooking device 100. In FIG. 14A, lid 20 includes handles 13B, and base 10 includes handles 13A. Lid 20 also includes a central handle 512 to facilitate lifting of lid 20 from base 10. Yolk holder 500 is positioned in the center of base 10. It should be noted that the design illustrated in FIGS. 14A-14-C is a two-piece design with yolk cap integrated in lid 20.

In FIG. 14B, a single alignment tab 506 is formed in base 10 for circumferential alignment of lid 20 with base 10. As illustrated in FIG. 14C, lid 20 includes two alignment notches 504 formed by gaps in a spacer 514. When either alignment notch 504 is aligned with alignment tab 506, handles 13A and 13B will be vertically aligned. Spacer 514 rests on a sloped surface 516 within the inner circumference of base 10. The height of spacer 514 may be set so that yolk cap 30 is suspended a sufficient distance above the cooking surface of base 10 to prevent yolk cap 30 from making an impression in the egg white during cooking.

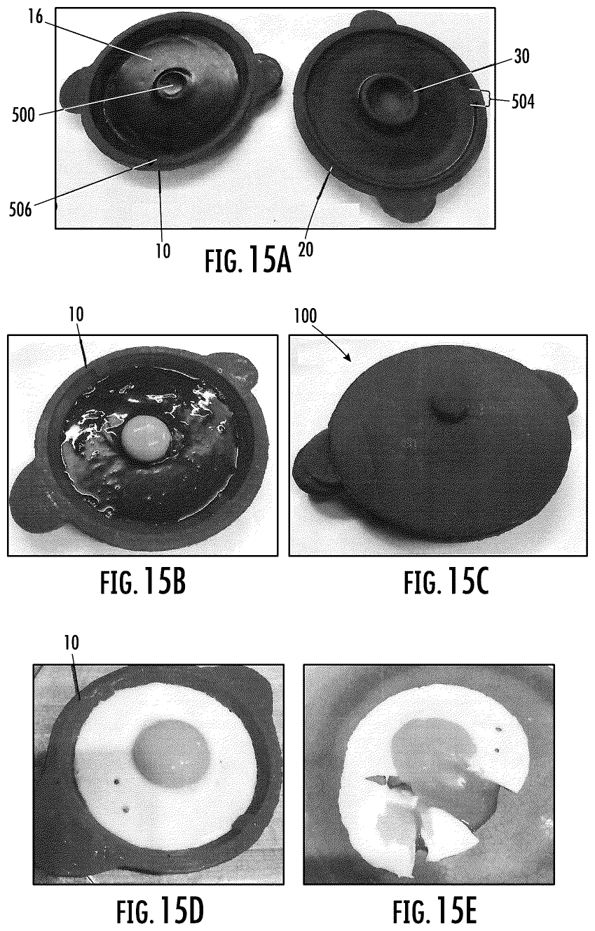

FIGS. 15A-15D are images of cooking device 100 and FIG. 15E is an image of a sunny side up egg cooked using cooking device 100. FIG. 15A illustrates base 10 showing yolk holder 500, base surface 16, and alignment tab 506. FIG. 15A also illustrates the underside of lid 20 including yolk cap 30 and alignment notch 504. FIG. 15B is a top view of base 10 with an uncooked egg located therein. FIG. 15C illustrates cooking device 100 in the closed position with lid 20 positioned on top of base 10. FIG. 15D is an image of a cooked egg located in base 10. FIG. 15E illustrates that the egg has a runny yolk and a coagulated white, indicating a sunny-side-up egg successfully cooked using cooking device 100.

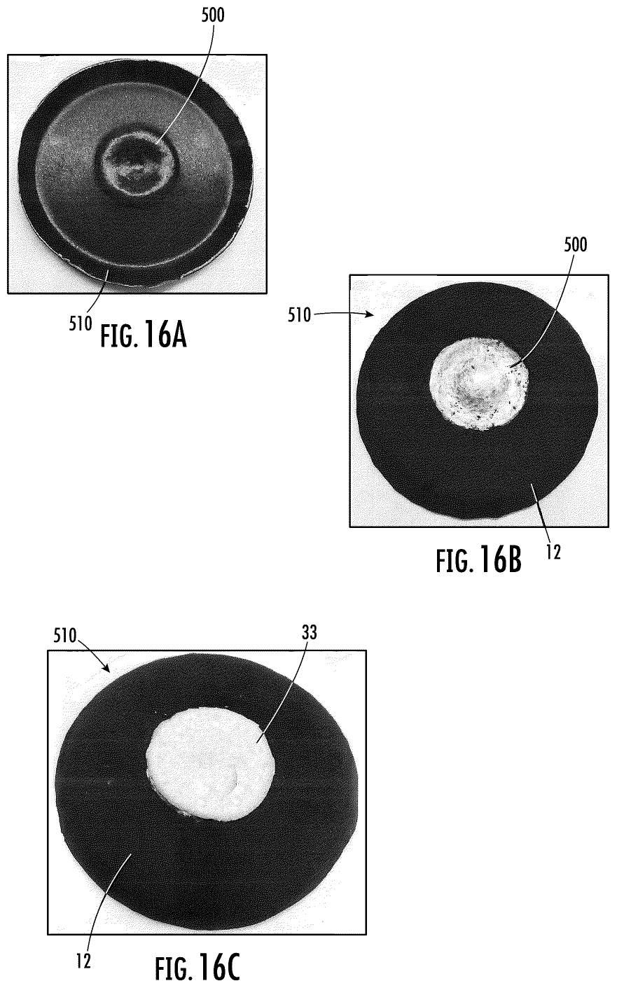

FIGS. 16A-16C are images of cooking plate 510 and susceptor 12 prior to silicone overmolding. FIG. 16A is a top view of cooking plate 510 illustrating yolk holder 500. FIG. 16B is a bottom view of cooking plate 510 illustrating susceptor 12 forming the central aperture under yolk holder 500. FIG. 16C is a bottom view of cooking plate 510 illustrating susceptor 12 and phase change material 33 located in the central aperture under yolk holder 500.

The features of the subject matter illustrated and described herein are examples. Therefore, it is understood that the appended claims are intended to cover unforeseeable embodiments with insubstantial differences that are within the spirit of the claims.

What is claimed is:

1. A cooking device that allows food to be cooked in a microwave or rapid cook oven, the cooking device comprising:
a base having a top surface and a bottom surface, the base having at least one receptacle, wherein the at least one receptacle extends from the top surface of the base towards the bottom surface of the base forming a cavity having a base surface, the base comprising at least one susceptor and an insulator, wherein the at least one susceptor is embedded in the insulator, wherein the at least one susceptor is positioned to be in thermal contact with the base surface of the at least one receptacle; and
a lid having a top surface and a bottom surface, the lid comprising an insulator and at least one shield, wherein the at least one shield is embedded in the insulator of the lid and shaped to cover the at least one receptacle, wherein the bottom surface of the lid is sized and shaped to cover the at least one receptacle.

2. A cooking device that allows food to be cooked in a microwave or rapid cook oven, the cooking device comprising:
a base having a top surface and a bottom surface, the base having at least one receptacle, wherein the at least one receptacle extends from the top surface of the base towards the bottom surface of the base forming a cavity having a base surface, the base comprising at least one susceptor and an insulator, wherein the at least one susceptor is embedded in the insulator, wherein the at least one susceptor is positioned to be in thermal contact with the base surface of the at least one receptacle; and
at least one yolk cap having a top surface and a bottom surface, the at least one yolk cap comprising a phase change material and an insulator, wherein the phase change material is embedded in the insulator of the at least one yolk cap, wherein the phase change material is in thermal contact with the bottom surface of the at least one yolk cap, and wherein the at least one yolk cap is sized and shaped to cover at least a portion of the at least one receptacle.

3. The cooking device of claim 2 further comprising:
a lid having a top surface and a bottom surface, the lid comprising an insulator and at least one shield, wherein the at least one shield is embedded in the insulator of the lid and shaped to cover the receptacle, wherein the bottom surface of the lid is sized and shaped to cover the receptacle.

4. The cooking device of claim 1 wherein the at least one susceptor is embedded within the insulator of the base between the base surface of the at least one receptacle and the bottom surface of the base.

5. The cooking device of claim 1 wherein the at least one susceptor is thermally insulated from the bottom surface of the base.

6. The cooking device of claim 1 wherein the base comprises:
a first side;
a second side; and
two handles, wherein the handles extend outward from the first side and the second side of the base.

7. The cooking device of claim 1 wherein the at least one susceptor is made from metalized thin films, ceramics or metals.

8. The cooking device of claim 1 wherein the insulator of the base is made from silicone.

9. The cooking device of claim 1 wherein the base surface is circular.

10. The cooking device of claim 2 further comprising a cage, the cage is fixedly attached to the at least one yolk cap and is sized to fit within the receptacle and hold the at least one yolk cap in a fixed position.

11. The cooking device of claim 2 wherein the at least one yolk cap is in the shape of a dome.

12. The cooking device of claim 2 wherein the at least one yolk cap is sized and shaped to cover at least one egg yolk.

13. The cooking device of claim 2 wherein the insulator of the yolk cap is a thermal insulator.

14. The cooking device of claim 2 wherein the insulator of the at least one yolk cap is made from food grade silicone.

15. The cooking device of claim 2 wherein the phase change material has a transition temperature below 65 degrees Celsius.

16. The cooking device of claim 2 wherein the phase change material is made from Croda Therm 60.

17. The cooking device of claim 2 wherein the phase change material comprises a wax.

18. The cooking device of claim 17 wherein the wax comprises beeswax.

19. The cooking device of claim 1 wherein the lid further comprises at least one yolk cap, the at least one yolk cap having a top surface and a bottom surface, wherein the top surface of the at least one yolk cap is fixed to the bottom surface of the lid, the at least one yolk cap comprising a phase change material and an insulator, wherein the phase change material is embedded in the insulator of the at least one yolk cap, wherein the phase change material is positioned to be in thermal contact with the bottom surface of the at least one yolk cap, and wherein the at least one yolk cap is sized and shaped to cover at least a portion of the at least one receptacle.

20. The cooking device of claim 19 wherein the phase change material has a transition temperature below 65 degrees Celsius.

21. The cooking device of claim 20 wherein the phase change material comprises CrodaTherm 60.

22. The cooking device of claim 20 wherein the phase change material comprises a wax.

23. The cooking device of claim 22 wherein the wax comprises beeswax.

24. The cooking device of claim 19 wherein the base comprises at least one yolk holder comprising an annulus for centering at least one egg yolk within the at least one receptacle of the base.

25. The cooking device of claim 24 wherein the at least one susceptor comprises at least one central aperture located below the at least one yolk holder.

26. The cooking device of claim 25 wherein the base comprises a phase change material located in the at least one central aperture of the at least one susceptor.

27. The cooking device of claim 24 wherein one of the base and the lid includes at least one alignment tab and the other of the base and the lid includes at least one alignment notch, wherein the at least one alignment tab is configured to engage the at least one alignment notch to align the lid and the base.

28. The cooking device of claim 27 wherein the at least one alignment tab and the at least one alignment notch are configured to vertically space the yolk holder from the base.

29. The cooking device of claim 1 wherein the insulator of the lid is made of silicone.

30. The cooking device of claim 1 wherein the at least one shield is made of a conductive material including at least one of: copper, brass, nickel, silver, steel and tin.

31. The cooking device of claim 1 wherein the bottom surface of the lid is shaped to form at least one dome.

32. The cooking device of claim 1 wherein the bottom surface of the lid is sized and shaped to cover a plurality of foods within the at least one receptacle.

33. The cooking device of claim 1 wherein the at least one receptacle comprises a plurality of receptacles, each including a base surface, wherein the at least one susceptor comprises a single susceptor positioned to be in thermal contact with the base surfaces of the receptacles.

34. The cooking device of claim 1 wherein:
the at least one receptacle comprises a plurality of receptacles, each including a base surface; and
the at least one susceptor comprises a plurality of susceptors, wherein the susceptors are positioned to be in thermal contact with the base surfaces of the receptacles.

35. The cooking device of claim 1 wherein:
the at least one receptacle comprises a plurality of receptacles, each including a base surface and the at least one susceptor comprises a plurality of susceptors, wherein the susceptors are positioned to be in thermal contact with the base surfaces of the receptacles;
wherein the at least one shield comprises a plurality of shields, the bottom surface of the lid is shaped to cover the receptacles in the base and each of the shields is positioned over one of the receptacles.

36. The cooking device of claim 2 wherein:
the at least one receptacle comprises a plurality of receptacles, each including a base surface and the at least one susceptor comprises a plurality of susceptors, wherein the susceptors are positioned to be in thermal contact with the base surfaces of the receptacles; and
the at least one yolk cap comprises a plurality of yolk caps, wherein the yolk caps are capable of covering at least a portion of each of the receptacles.

37. The cooking device of claim 1 wherein the insulator of the lid is made of silicone.

38. A method of cooking food in a microwave or rapid cook oven comprising:
providing or obtaining a cooking device comprising a base having a top surface and a bottom surface, the base having at least one receptacle, wherein the at least one receptacle extends from the top surface of the base towards the bottom surface of the base forming a cavity having a base surface, the base comprising a susceptor and an insulator, wherein the susceptor is embedded in the insulator, wherein the susceptor is positioned to be in thermal contact with the base surface of the at least one receptacle;
providing or obtaining, as part of the cooking device, at least one yolk cap having a top surface and a bottom surface, the at least one yolk cap comprising a phase change material and an insulator, wherein the phase change material is embedded in the insulator of the at least one yolk cap, wherein the phase change material is in thermal contact with the bottom surface of the at least one yolk cap, and wherein the at least one yolk cap is sized and shaped to cover at least a portion of the at least one receptacle;
providing or obtaining, as part of the cooking device, a lid having a top surface and a bottom surface, the lid comprising an insulator and a shield, wherein the shield is embedded in the insulator of the lid and shaped to cover the receptacle in the base, wherein the bottom surface of the lid is sized and shaped to cover the at least one receptacle in the base;
placing at least one cracked egg having at least one egg white and at least one egg yolk in the at least one receptacle of the base;
placing the lid on the base with the at least one yolk cap aligned over the at least one egg yolk;
placing the cooking device including the at least one cracked egg in a cooking chamber of a microwave or rapid cook oven; and
activating the microwave or rapid cook oven to cook the at least one cracked egg.
